(19) United States
(12) Patent Application Publication
(10) Pub. No.: US 2015/0350959 A1
(43) Pub. Date: Dec. 3, 2015

(54) REDUCED LATENCY DURING RANDOM ACCESS PROCEDURE

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/291,984

(22) Filed: May 30, 2014

(51) Int. Cl. H04W 36/00; H04W 74/08; H04W 76/00

(52) U.S. Cl. CPC H04W 36/0016; H04W 36/0022; H04W 76/007; H04W 74/0833

(57) ABSTRACT

A user equipment (UE) reduces random access procedure delays when reselecting or redirecting from a cell of a first radio access technology (RAT) by preventing a persistence check before initiating the random access procedure. In one instance, the UE prevents the persistence check by preventing collection of system information including a scaling factor used for the persistence check before initiating the random access procedure.

### TECHNICAL FIELD

Aspects of the present disclosure relate generally to wireless communication systems, and more particularly, to reducing random access procedure delays when reselecting or redirecting from a current serving cell of a first radio access technology (RAT).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes preventing system information collection of a scaling factor for persistence check before initiating a random access procedure when reselecting or redirecting from a cell of a first RAT.

According to another aspect of the present disclosure, an apparatus for wireless communication includes means for initiating redirection or reselection from a cell of a first RAT. The apparatus may also include means for preventing system information collection of a scaling factor for persistence check before initiating a random access procedure when reselecting or redirecting from the cell of the first RAT.

Another aspect discloses a computer program product for wireless communications in a wireless network having a non-transitory computer-readable medium. The computer readable medium has non-transitory program code recorded thereon which, when executed by the processor(s), causes the processor(s) to perform the operation of preventing system information collection of a scaling factor for persistence check before initiating a random access procedure when reselecting or redirecting from a cell of a first RAT.

Another aspect discloses an apparatus for wireless communication and includes a memory and at least one processor coupled to the memory. The processor(s) is configured to prevent system information collection of a scaling factor for persistence check before initiating a random access procedure when reselecting or redirecting from a cell of a first RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a call flow diagram illustrating a network operation according to one or more aspects of the present disclosure.

FIG. 6 is a block diagram illustrating a wireless communication method for performing faster redirection according to aspects of the present disclosure.

FIG. 7 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

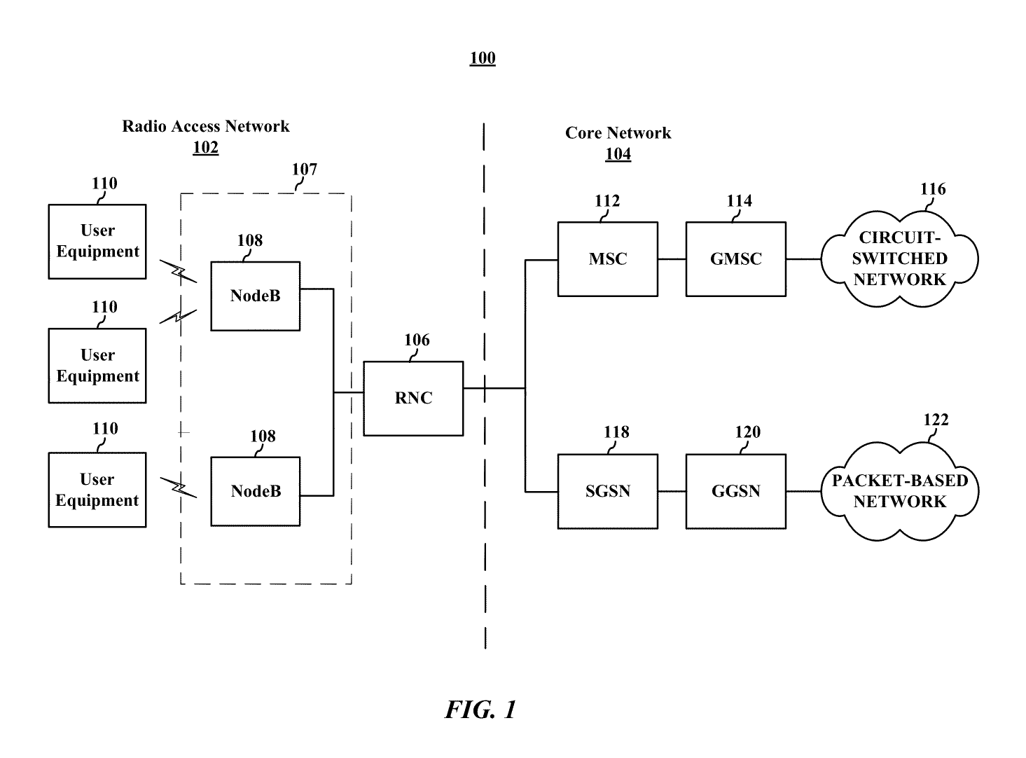

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 supports packet-data services with a serving general packet radio service (GPRS) support node (SGSN) 118 and a gateway GPRS support node (GGSN) 120. GPRS is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

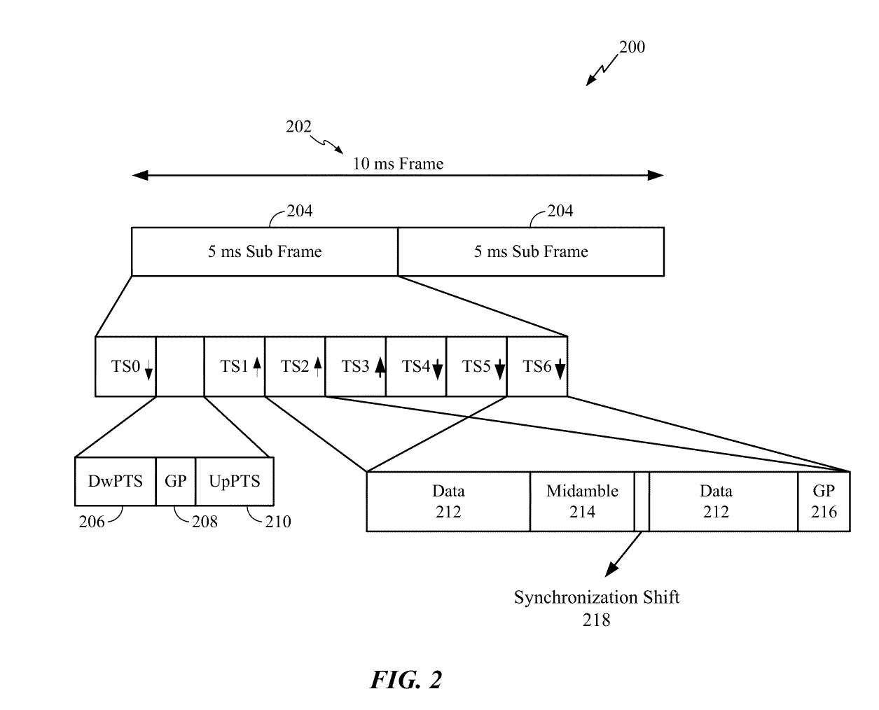

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

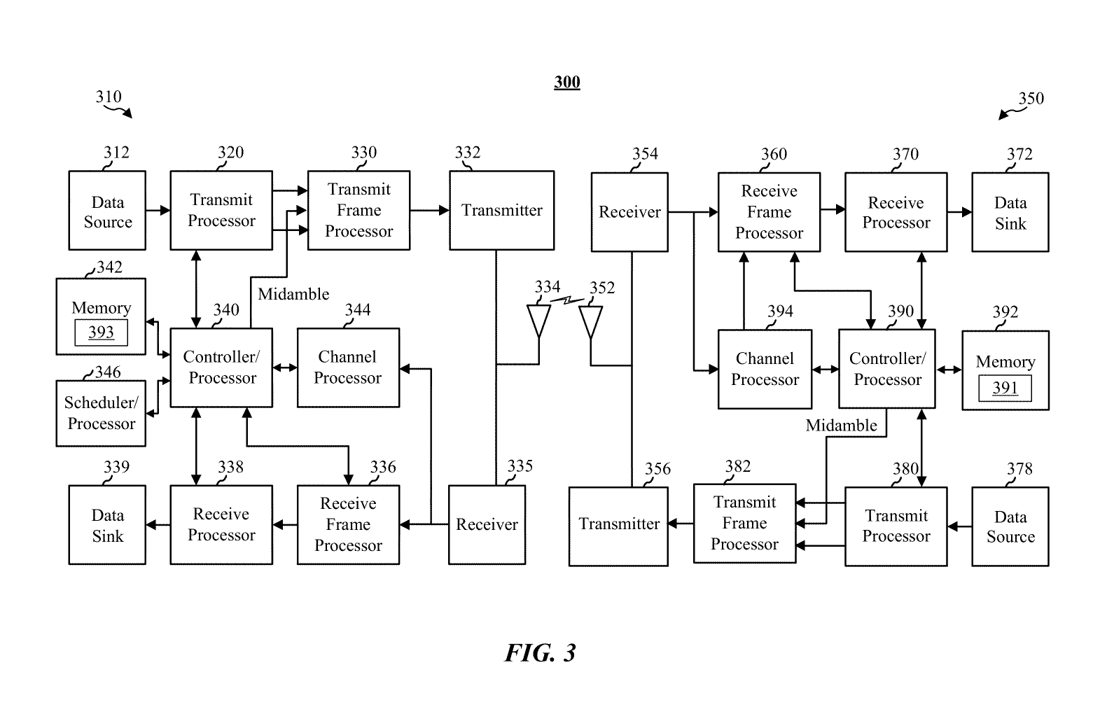

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a system information processing module 391 which, when executed by the controller/processor 390, configures the UE 350 to prevent system information collection of a scaling factor for persistence check before initiating a random access procedure when reselecting or redirecting from a cell of a first RAT. Similarly, the memory 342 of the node B 310 may store a connection release modifying module 393 which, when executed by the controller/processor 340, configures the node B 310 to perform a radio resource control procedure based on aspects of the present disclosure. A scheduler/processor 346 at the node B 310 may be used to allocate resources to the UEs and schedule downlink and/or uplink transmissions for the UEs.

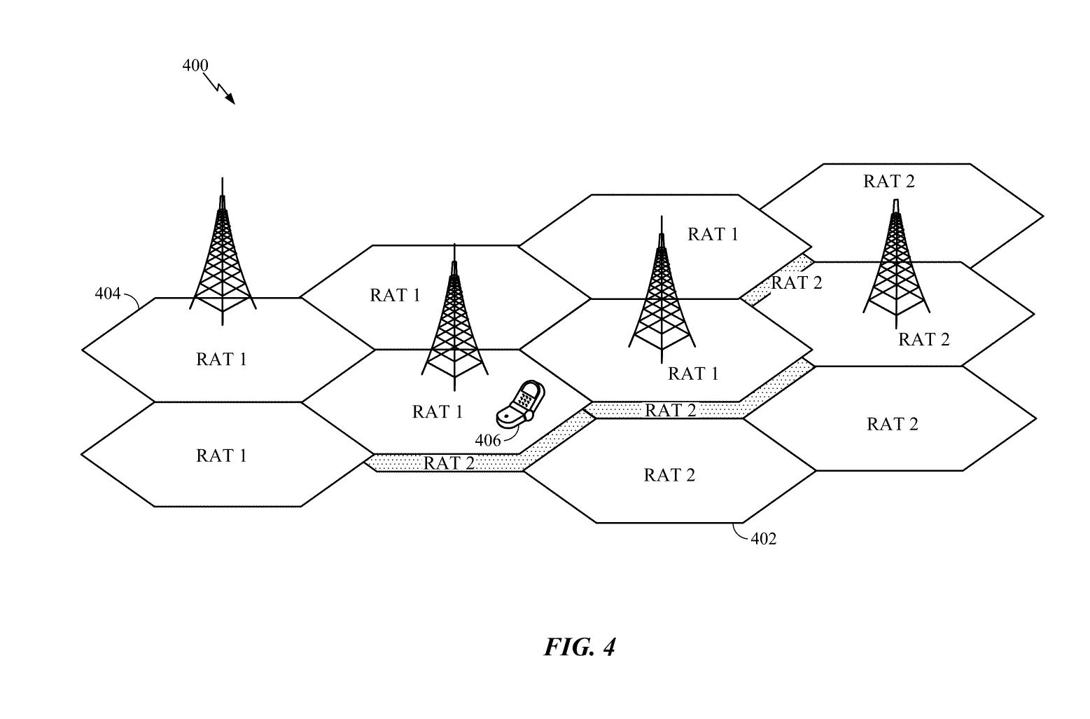

FIG. 4 illustrates coverage of a network utilizing a first type of radio access technology (i.e., RAT-1), such as a LTE network, and also coverage of a network utilizing a second type of radio access technology (i.e., RAT-2), such as a TD-SCDMA network. In this deployment of a network, a user equipment (UE) may be in the vicinity of the first RAT but continue to perform inter-radio access technology (inter-RAT) measurement of the second RAT. This measurement may be implemented for a cell or base station reselection or redirection procedure from the first RAT to the second RAT.

The geographical area 400 includes RAT-1 cells 404 and RAT-2 cells 402. In one example, the RAT-1 cells are LTE cells and the RAT-2 cells are TD-SCDMA cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station ID. The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold.

Redirection from one RAT to another RAT is commonly used to perform operations such as load balancing or circuit-switched fallback from one RAT to another RAT. For example, one of the RATs may be long term evolution (LTE) while the other RAT may be universal mobile telecommunications system—frequency division duplexing (UMTS FDD), universal mobile telecommunications system—time division duplexing (UMTS TDD), or global system for mobile communications (GSM). In some aspects, the redirection may be from a frequency or cell of one RAT to a frequency or cell of the same RAT.

Circuit-switched fallback (CSFB) is a feature that enables multimode user equipment (UE) to provide available circuit-switched (CS) voice services. Multimode UEs refer to UEs that are capable of communicating on a first RAT while connected to a second RAT. In one configuration, the first RAT is a third/second generation (3G/2G) mobile phone technology, such as TD-SCDMA, and the second RAT is LTE or vice versa. For example, a circuit-switched fallback capable UE may initiate a mobile-originated (MO) circuit-switched voice-call while on LTE. The initiated voice call may result in the UE being moved to a circuit-switched capable radio access network (RAN), such as 3G or 2G for a circuit-switched voice-call setup. A circuit-switched fallback capable UE may also be paged for a mobile-terminated (MT) voice call while on a specific RAT. The page may result in the UE being moved to another RAT for circuit switched voice call setup.

### Reduced Latency During Random Access Procedure

Aspects of the present disclosure are directed to reducing random access procedure delays when reselecting or redirecting from a current serving cell of a first radio access technology (RAT). The delays may be reduced by preventing a persistence check before initiating the random access procedure. In one aspect of the disclosure, a user equipment prevents the persistence check by preventing system information collection of a scaling factor used for the persistence check.

To reselect or redirect the UE to a different cell from the current serving cell, the UE may perform the persistence check prior to the random access procedure. The persistence check may be part of a cell acquisition procedure. The cell acquisition process includes system information collection. For example, when the UE is redirected to a TD-SCDMA network due to circuit switched fall back (CSFB) via an LTE connection release, the UE performs the cell acquisition procedure on the redirected TD-SCDMA frequency/cell.

The system information collection includes the collection of broadcasting system information messages. The broadcasting system information messages may include system information blocks (SIBs).

To perform the persistence check, the UE receives a scaling factor from a network in one of the system information blocks. The scaling factor may be a persistence value, Pᵢ, carried in SIB 7. The network may set Pᵢ based on a load of a physical random access channel (PRACH). In some instances, the persistence value is reduced when the load of the PRACH is high. For example, when the load of the PRACH is high (e.g., 0.9) the persistence value is reduced (e.g., 0.1). Otherwise, the persistence value is increased when the load of the PRACH is low. For example, when the load of the PRACH is low (e.g., 0.1) the persistence value is increased (e.g., 0.9).

The UE performs the persistence check to determine whether to perform the random access procedure (e.g., PRACH procedure) in a current transmission time interval based on the persistence value Pᵢ (e.g., 0.1, 0.2). For example, the UE creates a random number, R, between 0 and 1 and compares the random number to the persistence value.

When the random number is above or equal to the persistence value, a PRACH transmission is permitted in accordance with the PRACH procedure. The PRACH transmission may include transmission of a preamble, such as a random access preamble. In conjunction with the PRACH transmission, the UE transmits uplink synchronization (SYNC_UL) information and monitors a fast physical access channel (FPACH) for a random access response over a wait time (WT) corresponding to a number of subframes.

When the random number is below the persistence value, the PRACH transmission is not permitted and a new persistence check is performed in a next transmission time interval. The persistence check is repeated until transmission is permitted.

The persistence check, however, increases latency associated with the random access procedure and corresponding call setup latency. Moreover, the UE waits to collect SIB 7 and the corresponding persistence values for the persistence check, before commencing the random access procedure. As a result, performing the persistence check prior to performing the random access procedure increases the delay associated with the random access procedure, which increases the call setup latency.

In one aspect of the disclosure, some of the cell acquisition procedures, such as the persistence check, may be skipped prior to the random access procedure to reduce the delay to the random access procedure when reselecting or redirecting from the cell (i.e., current serving cell) of a first RAT. Thus, to reduce the delay, the UE prevents the persistence check and starts the random access procedure without performing the persistence check.

As noted, the UE prevents the persistent check by preventing collection of system information that includes the scaling factor. The scaling factor corresponds to the persistence value carried in the system information block (e.g., SIB 7). Thus, the UE does not wait to collect the persistence value carried in SIB 7 before performing the PRACH procedure.

In a particular configuration, the UE reduces time spent performing random access procedures for circuit switched fall back (CSFB) to a TD-SCDMA network. In this case, during the CSFB to the TD-SCDMA network, the UE bypasses or prevents the persistence check, i.e., and prevents collection of SIB 7, to expedite performance of the PRACH transmission.

In another configuration, the UE reduces time spent performing random access procedures for an emergency call. In this aspect, the UE reselects from a cell of a first RAT or is redirected from the cell of the first RAT in response to an emergency call procedure. Similar to the procedure for CSFB, the UE reduces the delay by preventing the persistence check and the collection of SIB 7.

As noted, the UE does not wait to collect SIB 7 and to perform a persistence check before performing the PRACH procedure. However, to perform the expedited PRACH procedure, the UE may collect other relevant system information. For example, the UE may only collect system information (e.g., master information blocks (MIBs) and SIBs that are relevant to performing the expedited PRACH procedure). The collection of all the other system information (i.e., system information that is not relevant to the PRACH procedure) may be skipped to expedite the PRACH procedure to reduce the call setup latency.

The relevant system information may include system information indicating which random access response channel to monitor, system information indicating which random access channel to send the preamble and system information indicating which preambles to send. For example, the random access preamble may be transmitted at an earliest opportunity after collecting the system information indicating which random access response channel to monitor, the system information indicating which random access channel to send the preamble and the system information indicating which preambles to send.

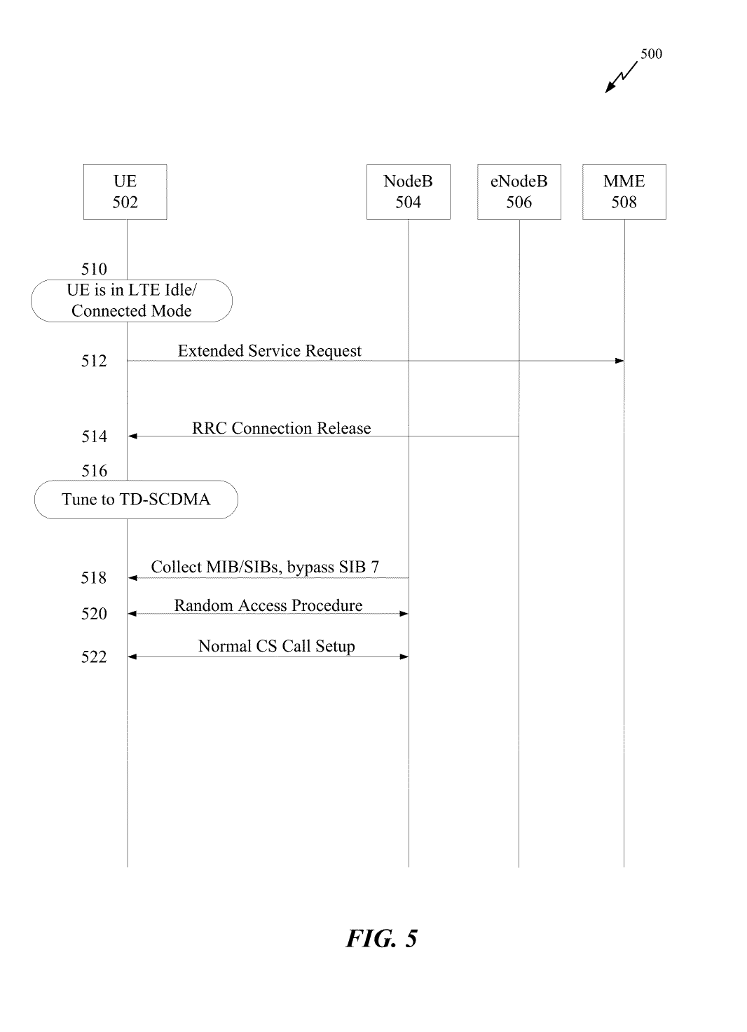

FIG. 5 is a call flow diagram 500 illustrating a network operation according to one or more aspects of the present disclosure. A UE 502 may be engaged in communications with a TD-SCDMA NodeB 504, and/or an LTE eNodeB (or base station) 506. In FIG. 5, the UE communicates with a mobility management entity (MME) 508 via the eNodeB 506. At time 510, the UE 502 is in idle mode or connected mode in the LTE network. At time 512, the UE 502 transmits an extended service request to the MME 508. The extended service request may be an indicator for a mobile-originated (MO) or mobile-terminated (MT) circuit-switched fallback (CSFB) call. For example, the extended service request may indicate a circuit-switched fallback call is desired.

At time 514, the eNodeB 506 transmits a connection release message to the UE 502, such as a radio resource control (RRC) connection release message. The RRC connection release message may include the TD-SCDMA redirection information but not the system information blocks. At time 516, the UE 502 tunes to the TD-SCDMA frequency.

At time 518, the UE 502 collects, from the TD-SCDMA NodeB 504, the master information block (MIB) and some system information blocks (SIBs). In one aspect of the disclosure, the UE does not collect SIB 7. For example, the UE prevents the collection of SIB 7 (if SIB 7 is not already collected) and prevents performance of the persistence check before performing the random access procedure. For example, the UE only collects the relevant system information and then continues to perform the random access procedure at time 520. At this time, the UE 502 and the TD-SCDMA NodeB 504 are in communication with each other to perform a random access procedure. At time 522, the UE 502 and the TD-SCDMA NodeB 504 perform a normal circuit-switched (CS) call setup.

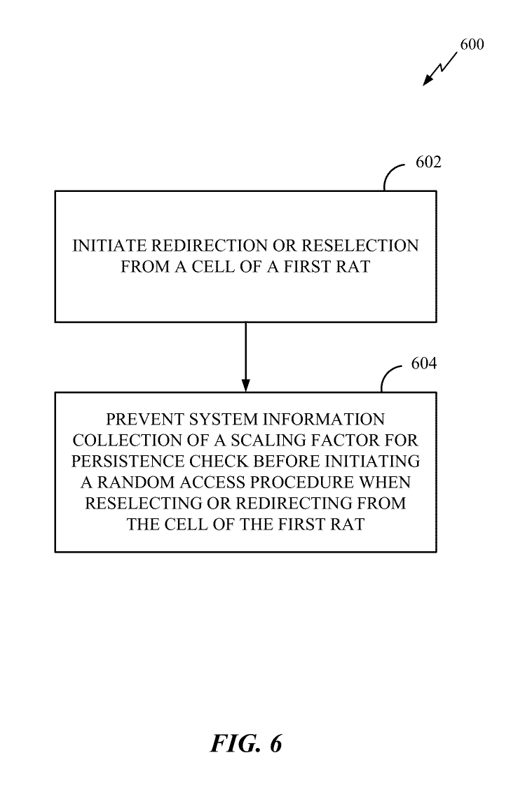

FIG. 6 is a block diagram illustrating a wireless communication method 600 according to one or more aspects of the present disclosure. A UE initiates reselection or redirection from a cell of a first RAT, as shown in block 602. The UE prevents system information collection of a scaling factor for persistence check before initiating a random access procedure when reselecting or redirecting from the cell of the first RAT, as shown in block 604.

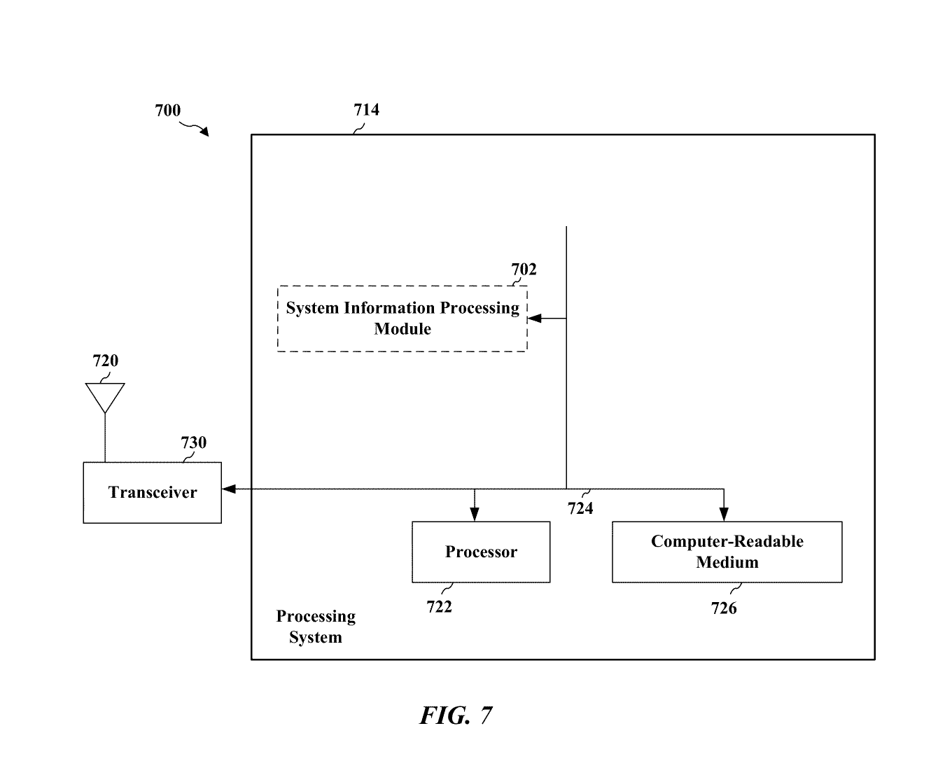

FIG. 7 is a diagram illustrating an example of a hardware implementation for an apparatus 700 employing an information processing system 714. The information processing system 714 may be implemented with a bus architecture, represented generally by the bus 724. The bus 724 may include any number of interconnecting buses and bridges depending on the specific application of the information processing system 714 and the overall design constraints. The bus 724 links together various circuits including one or more processors and/or hardware modules, represented by the processor 722, the system information processing module 702, and the computer-readable medium 726. The bus 724 may also link various other circuits such as timing sources, peripherals, voltage regulators, and power management circuits, which are well known in the art, and therefore, will not be described any further.

The apparatus includes an information processing system 714 coupled to a transceiver 730. The transceiver 730 is coupled to one or more antennas 720. The transceiver 730 enables communicating with various other apparatus over a transmission medium. The information processing system 714 includes a processor 722 coupled to a computer-readable medium 726. The processor 722 is responsible for general processing, including the execution of software stored on the computer-readable medium 726. The software, when executed by the processor 722, causes the information processing system 714 to perform the various functions described for any particular apparatus. The computer-readable medium 726 may also be used for storing data that is manipulated by the processor 722 when executing software.

The information processing system 714 includes a system information processing module 702 for preventing system information collection of a scaling factor for persistence check before initiating a random access procedure when reselecting or redirecting from a cell of a first RAT. The modules may be software modules running in the processor 722, resident/stored in the computer-readable medium 726, one or more hardware modules coupled to the processor 722, or some combination thereof. The information processing system 714 may be a component of the UE 350 and may include the memory 392, and/or the controller/processor 390.

In one configuration, an apparatus, such as an UE 350, is configured for wireless communication including means for preventing. In one aspect, the above means may be the receiver 354, antenna 352/720, the receive processor 370, the transceiver 730, the controller/processor 390, the memory 392, the system information processing module 391/702, the processor 722, and/or the information processing system 714 configured to perform the functions recited by the aforementioned means. In another aspect, the aforementioned means may be a module or any apparatus configured to perform the functions recited by the aforementioned means.

In another configuration, the apparatus configured for wireless communication also includes means for initiating. In one aspect, the above means may be the receiver 354, antenna 352/720, the receive processor 370, the transceiver 730, the transmitter 356, the transmit processor, the controller/processor 390, the memory 392, the system information processing module 391, the processor 722, and/or the information processing system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing global system for mobile communications (GSM), long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
preventing system information collection of a scaling factor for persistence check before initiating a random access procedure when reselecting or redirecting from a cell of a first RAT.

2. The method of claim 1, in which the scaling factor comprises a persistence value.

3. The method of claim 1, in which the reselecting or redirecting occurs in response to a circuit switched fall back (CSFB) procedure.

4. The method of claim 1, in which the reselecting or redirecting occurs in response to an emergency call procedure.

5. The method of claim 1, further comprising sending a random access preamble at an earliest opportunity after collecting system information indicating which random access preambles to send, on which random access channel to send the random access preambles, and which random access response channel to monitor.

6. An apparatus for wireless communication, comprising:
means for initiating redirection or reselection from a cell of a first RAT; and
means for preventing system information collection of a scaling factor for persistence check before initiating a random access procedure when reselecting or redirecting from the cell of the first RAT.

7. The apparatus of claim 6, in which the scaling factor comprises a persistence value.

8. The apparatus of claim 6, in which the reselecting or redirecting occurs in response to a circuit switched fall back (CSFB) procedure.

9. The apparatus of claim 6, in which the reselecting or redirecting occurs in response to an emergency call procedure.

10. The apparatus of claim 6, further comprising means for sending a random access preamble at an earliest opportunity after collecting system information indicating which random access preambles to send, on which random access channel to send the random access preambles, and which random access response channel to monitor.

11. An apparatus for wireless communication, comprising:
a memory; and
at least one processor coupled to the memory and configured:
to prevent system information collection of a scaling factor for persistence check before initiating a random access procedure when reselecting or redirecting from a cell of a first RAT.

12. The apparatus of claim 11, in which the scaling factor comprises a persistence value.

13. The apparatus of claim 11, in which the reselecting or redirecting occurs in response to a circuit switched fall back (CSFB) procedure.

14. The apparatus of claim 11, in which the reselecting or redirecting occurs in response to an emergency call procedure.

15. The apparatus of claim 11, in which the at least one processor is further configured to send a random access preamble at an earliest opportunity after collecting system information indicating which random access preambles to send, on which random access channel to send the random access preambles, and which random access response channel to monitor.

16. A computer program product for wireless communication, comprising:
a non-transitory computer-readable medium having program code recorded thereon, the program code comprising:
program code to prevent system information collection of a scaling factor for persistence check before initiating a random access procedure when reselecting or redirecting from a cell of a first RAT.

17. The computer program product of claim 16, in which the scaling factor comprises a persistence value.

18. The computer program product of claim 16, in which the reselecting or redirecting occurs in response to a circuit switched fall back (CSFB) procedure.

19. The computer program product of claim 16, in which the reselecting or redirecting occurs in response to an emergency call procedure.

20. The computer program product of claim 16, further comprising program code to send a random access preamble at an earliest opportunity after collecting system information indicating which random access preambles to send, on which random access channel to send the random access preambles, and which random access response channel to monitor.
